(19) United States
(12) Patent Application Publication
(10) Pub. No.: US 2018/0191226 A1
(43) Pub. Date: Jul. 5, 2018

(54) MOTOR AND MOTOR SHAFT TO PREVENT AXIAL SLIPPAGE

(71) Applicant: Alexander D. Walter, Holmdel, NJ (US)

(72) Inventor: Alexander D. Walter, Holmdel, NJ (US)

(21) Appl. No.: 15/396,580

(22) Filed: Dec. 31, 2016

(51) Int. Cl. H02K 7/116; F16D 1/08; F16H 57/00; F16C 3/02

(52) U.S. Cl. CPC H02K 7/116; F16C 3/02; F16H 57/0025; F16D 1/0847

(57) ABSTRACT

A motor and motor shaft, the shaft including a cylindrical-shaped first portion, a second portion having a D-shaped cross section, and a surface feature on the motor shaft, the surface feature configured to prevent a set screw from sliding axially along a major axis of the motor shaft. The surface feature may be a notch or ridge. A notch may extend at least partially circumferentially around the shaft. The set screw may be received either within the surface feature or between adjacent surface features. The motor includes the motor shaft.

### FIELD

Embodiments of the invention pertain to a motor and motor shaft designed to prevent axial slippage of an attached pinion gear or the like.

### BACKGROUND

Small motors, e.g., sizes known as National Electrical Manufacturers Association (NEMA) 8, 11, 14, 17 and 23, or servo motors, are often used with timing pulleys, pulley gears, pinion gears and the like (generically, “pinion gears”) to move another object, either as a linear motion (FIG. 1A) or as a rotational movement to another shaft located remotely (FIG. 1B), where a direct transfer of motion by gears is not desirable. For example, shaft 1 and shaft 2 may be located relatively far apart, or may be isolated to reduce vibrational coupling, etc.

Pinion gears may be secured to a shaft by use of a set screw, barrel screw or the like (generically, “set screw”), particularly if the pinion gear is intended to be removable from the shaft. A bonding agent to bond the pinion gear to the shaft would not be used if the pinion gear is intended to be removable, i.e., by being removeably secured. Although the shaft may have an entirely circular cross-sectional shape, this presents a curved surface to the set screw, which will be prone to rotational slippage between the set screw and the shaft. Therefore, the shaft often includes a flat portion to receive the set screw, in order to reduce or eliminate rotational slippage. Such shafts are known as a D-shaft or D-shaped shaft. An arc formed from a curved potion of the D-shaft commonly has an angular range of about 180 degrees to about 330 degrees. FIG. 2A illustrates a motor with a D-shaped motor shaft as known in the art. The motor includes a housing to enclose electromagnetic coils, and the D-shaped motor shaft is rotatably coupled to the housing. A portion of the motor shaft extends within the electromagnetic coils, and the motor shaft is rotated by electromagnetic force. FIG. 2B illustrates a pinion gear with an uninserted set screw, as known in the art.

Timing belts 3, 4 in FIGS. 1A-1B must be tight, with a relatively large amount of tension in the timing belt, in a direction transverse to a major axis of the shaft. If there is not enough tension, there will be undesirable backlash as the direction of rotation changes, and/or there will be a reduction in the amount of torque that can be applied without slippage.

However, shaft 1 and shaft 2 may not be perfectly parallel. Such a lack of parallelism may be caused by, e.g., installation tolerances such as from installing on blocks of wood, creep over time, and so forth. If not parallel, the tightness of the timing belt will impart a small force on the pinion gear along the direction of shaft 1 and/or shaft 2. Unlike how the flat surface of a D-shaft allows a set screw to lock the pinion to rotational movement of the shaft, only friction between the set screw and the shaft keeps the pinion from sliding longitudinally, along the axial length of the shaft. Over time, as the system is operated and flexed, the pinion gears may “walk” toward the end of the shaft that would reduce tension on the timing belt. If that end of the shaft is open (as with a motor shaft), the pinion may eventually fall off the shaft, causing a system failure.

Therefore, a need exists to reduce axial (i.e., longitudinal) slippage of a pinion gear when installed on a shaft.

### SUMMARY OF THE INVENTION

Embodiments of the invention include a shaft with non-planar surface features that prevent a coupled pinion gear from slipping or sliding axially over time as the pinion gear is operated under a transverse tension.

Embodiments in accordance with the present disclosure provide a motor and motor shaft, the shaft including a cylindrical-shaped first portion, a second portion having a D-shaped cross section, and a surface feature on the motor shaft, the surface feature configured to prevent a set screw from sliding axially along a major axis of the motor shaft. The surface feature may be a notch or ridge. A notch may extend at least partially circumferentially around the shaft. The set screw may be received either within the surface feature or between adjacent surface features. The motor includes the motor shaft.

### BRIEF DESCRIPTION OF THE DRAWINGS

The above and still further objects, features and advantages of the present invention will become apparent upon consideration of the following detailed description of a specific embodiment thereof, especially when taken in conjunction with the accompanying drawings wherein like reference numerals in the various figures are utilized to designate like components, and wherein:

FIG. 1A is a planar view of a timing belt to move an object laterally, as known in the art;

FIG. 1B is a planar view of a timing belt to rotate a remote object, as known in the art;

FIG. 2A is a perspective view of a motor with D-shaft, as known in the art;

FIG. 2B is a perspective view of a pinion gear and set screw, as known in the art;

FIG. 3 is a misaligned timing belt system, in accordance with an embodiment of the present disclosure;

FIG. 4A is a planar view of a motor and shaft, as known in the art;

FIGS. 4B-4E are planar views of a motor and notched shaft, in accordance with an embodiment of the present disclosure;

FIGS. 5A-5C are planar views of a motor and ridged shaft, in accordance with an embodiment of the present disclosure;

FIG. 6A illustrates an oblique view of a motor and ridged shaft, in accordance with an embodiment of the present disclosure; and

FIG. 6B illustrates an oblique view of a motor and notched shaft, in accordance with an embodiment of the present disclosure.

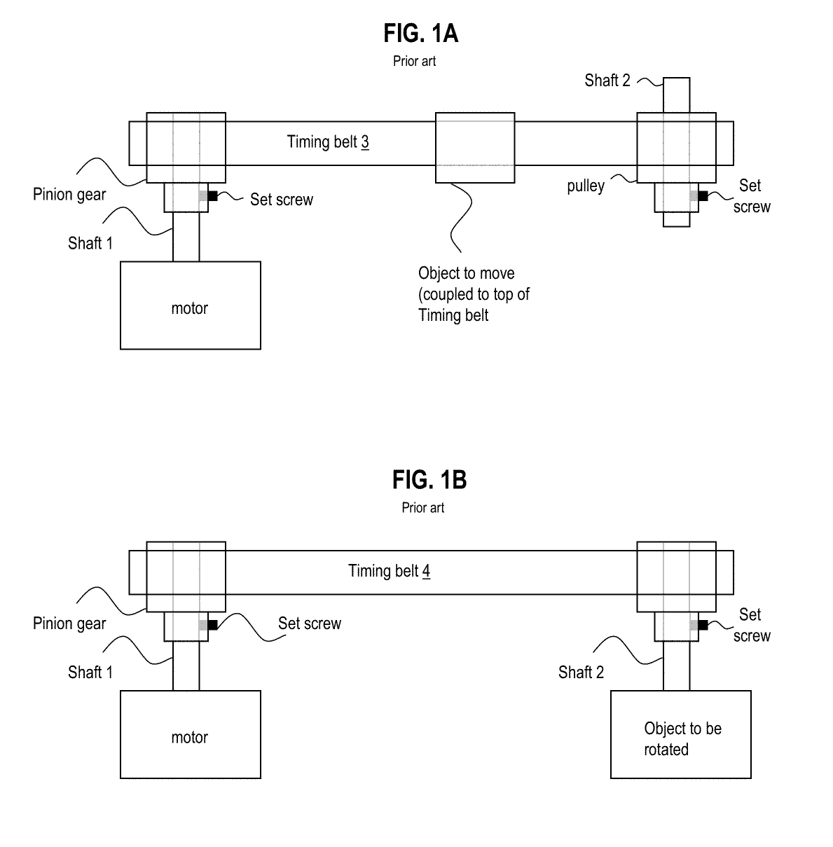

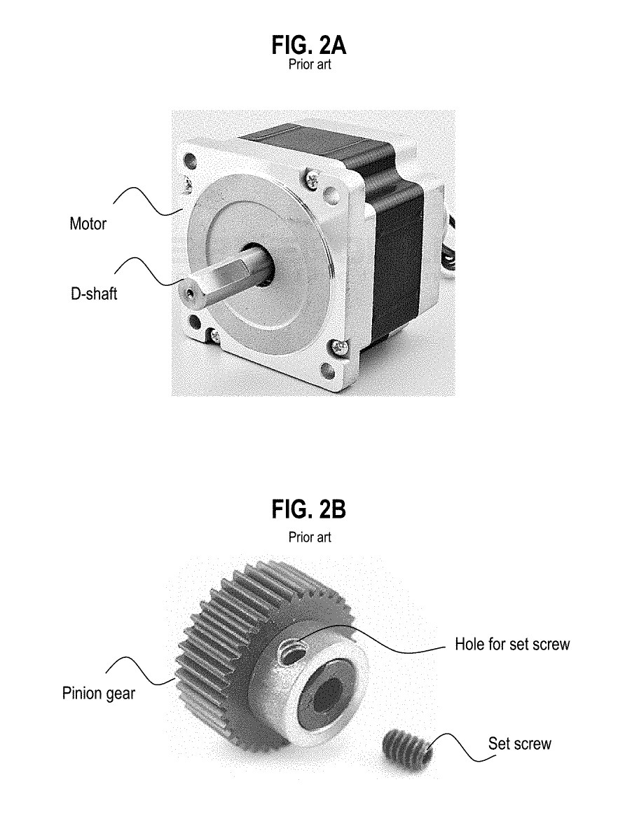

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures. Optional portions of the figures may be illustrated using dashed or dotted lines, unless the context of usage indicates otherwise. The figures are not drawn to scale unless explicitly so stated, or if clearly intended by the context of the figures.

### DETAILED DESCRIPTION

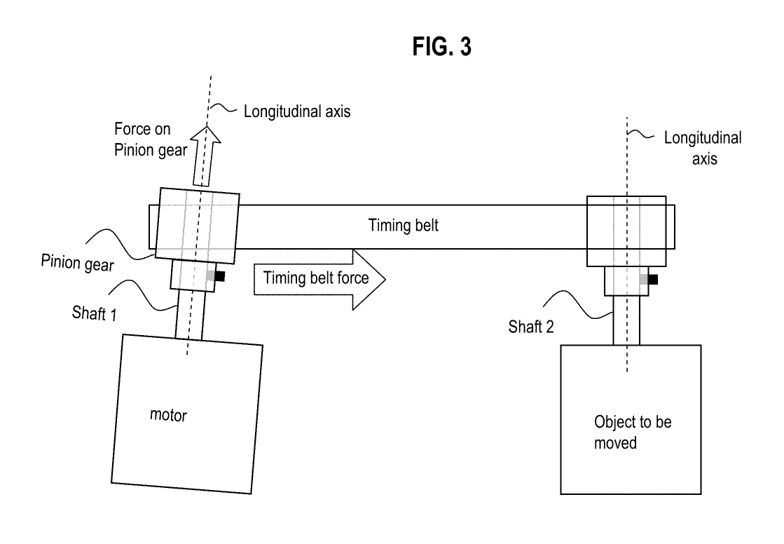

In some installations of a motor, pinion and timing belt system may have misaligned motors. See the exaggerated view in FIG. 3. Such systems are susceptible to creep or movement axially of a pinion gear over time, caused by tension in the timing belt. Similar systems such as a chain and sprocket system also may be susceptible to the same problem. Embodiments in accordance with the present disclosure are usable in the system of FIG. 3 in order to prevent such axial creep or movement of a pinion gear over time.

Embodiments in accordance with the present disclosure prevent axial slippage of a pinion gear on a shaft by adding surface features to a shaft (e.g., a motor shaft). The surface features will couple with a set screw, to prevent the pinion gear from working its way along the length of the shaft.

As used herein, “axial” or “axially” refers to a direction parallel to a major axis of a shaft. As used herein, “transverse” refers to a direction perpendicular to an axial direction.

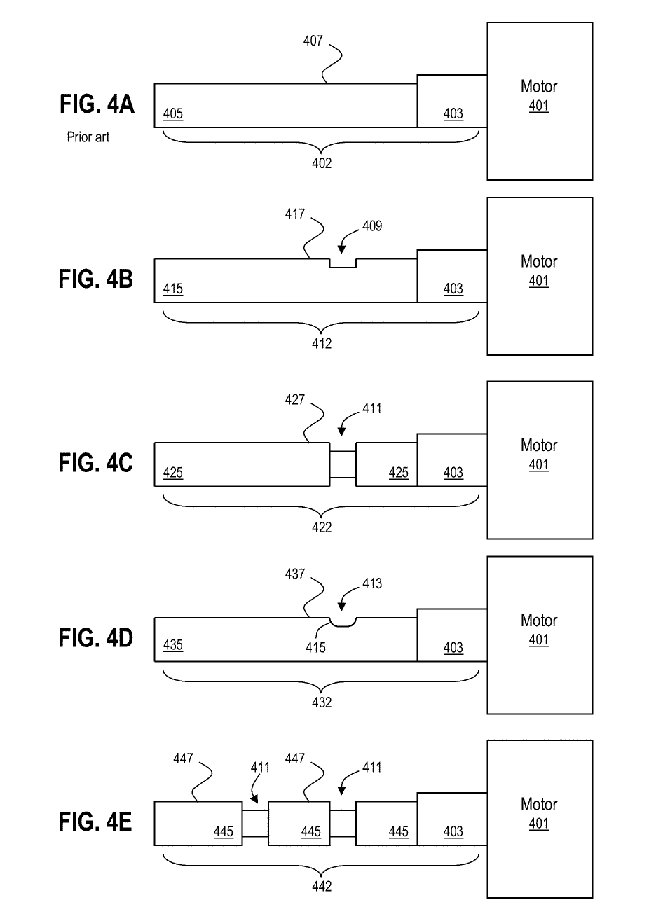

FIG. 4A illustrates a conventional arrangement of motor 401 and D-shaft 402 as known in the art. D-shaft 402 includes a first section 403 having a substantially circular cross-sectional shape in a plane perpendicular to the plane of FIG. 4A. D-shaft 402 includes a second section 405 that has a cross-sectional shape substantially similar to the letter “D”, in a plane perpendicular to the plane of FIG. 4A. In particular, second section 405 includes a surface 407 that is planar in a plane perpendicular to the plane of FIG. 4A. Standard diameters of at least first section 403 include one of 5 mm, 8 mm, and 0.25 inches.

FIGS. 4B-4E illustrate side plan views of various embodiments in accordance with the present disclosure, illustrating surface feature(s) as one or more notches in a motor shaft, in order to prevent axial slippage of a pinion gear (not illustrated in FIGS. 4B-4E). The notches are configured to receive at least one set screw from the pinion gear. The set screw typically may be about 1 mm in diameter and about 2-3 mm in length in its threaded portion.

FIG. 4B illustrates motor 401 coupled to shaft 412. Shaft 412 includes section 415 having a flat surface 417. Within or adjacent to flat surface 417 is a single notch 409. Notch 409 extends in a transverse direction, i.e., in a direction perpendicular to the plane of FIG. 4B. Notch 409 includes a flat surface parallel to flat surface 417.

FIG. 4C illustrates motor 401 coupled to shaft 422. Shaft 422 includes D-shaped sections 425 having a flat surface 427. Within or adjacent to D-shaped sections 425 is a single notch 411 that extends at least partially circumferentially around shaft 422. Notch 411 is configured to receive a set screw from a pinion gear (not illustrated in FIG. 4C). The at least partially circumferential notch allows for shaft 422 to couple securely with multiple set screws in a pinion. For example, a second set screw in the pinion may be located at a 90 degree offset from the first set screw, or a total of three set screws separated by 120 degrees, and so forth. Notch 411 itself has a D-shaped cross-sectional shape, but with a smaller diameter than the rest of D-shaped section 425.

FIG. 4D illustrates motor 401 coupled to shaft 432. Shaft 432 includes section 435 having a flat surface 437. Within flat surface 437 is a single notch 413. FIG. 4D is similar to FIG. 4B, however notch 413 differs from notch 409 in that notch 413 has relatively more rounded concave corners, to form a transition region between notch 413 and flat surface 437 of section 435. The embodiment of FIG. 4D may have less stress and strain during operation compared to the embodiment of FIG. 4B. However, the rounded corners of FIG. 4D should not be excessively rounded so that a set screw may slip out of notch 413. In other embodiments (not illustrated) a notch with rounded concave corners may extend at least partially circumferentially around shaft 422, similar to notch 411 extending at least partially circumferentially around shaft 422.

FIG. 4E illustrates motor 401 coupled to shaft 442. Shaft 442 includes a plurality of D-shaped sections 445 each having a respective flat surface 447. Within or adjacent to D-shaped sections 445 is a plurality of notches 411 that extends at least partially circumferentially around shaft 442. The embodiment of FIG. 4E is similar to the embodiment of FIG. 4C, however the plurality of notches 411 allows for set screws in a pinion to couple with shaft 442 at one of a plurality of axial positions along shaft 442. This may allow for additional flexibility or adjustability during installation, such that the pinion may be installed at one of a plurality of distances from motor 401. In other embodiments (not illustrated) a plurality of notches with rounded concave corners (similar to notch 413) may extend at least partially circumferentially around shaft 422, similar to notch 411 extending at least partially circumferentially around shaft 422. In other embodiments (not illustrated) a plurality of notches may extend transversely across around shaft 422, similar to the embodiments shown in FIGS. 4B, 4D, without extending at least partially circumferentially around shaft 442.

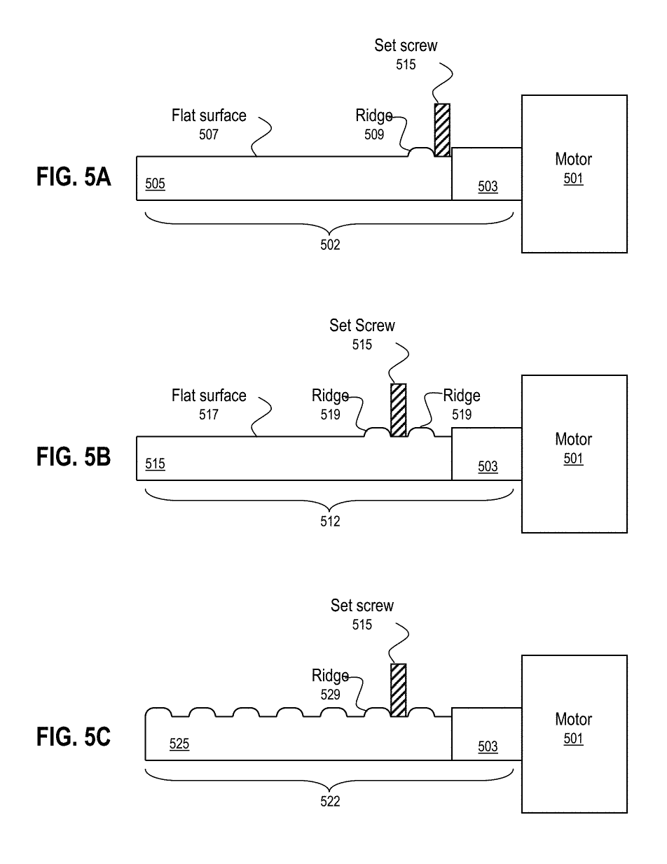

FIGS. 5A-5C illustrate side plan views of various embodiments in accordance with the present disclosure, illustrating surface feature(s) as one or more ridges in a motor shaft, in order to prevent axial slippage of a pinion gear (not illustrated in FIGS. 5A-5C). The ridges are configured to secure at least one set screw from the pinion gear. The set screw typically may be about 1 mm in diameter and about 2-3 mm in length in its threaded portion. Although the ridges are illustrated with rounded convex edges, in other embodiments the convex edges may be sharp. The ridges do not extend radially beyond a cylindrical envelope defined by the at least partially circumferential surface of section 503.

FIG. 5A illustrates motor 501 coupled to shaft 502. Shaft 502 includes a cylindrical section 503 having a substantially circular cross-sectional shape in a plane perpendicular to the plane of FIG. 5A. Shaft 502 also includes a section 505 having a flat surface 507. On flat surface 507 is a single ridge 509. Ridge 509 extends in a transverse direction, i.e., in a direction perpendicular to the plane of FIG. 5A. Since ridge 509 cannot extend radially beyond a cylindrical envelope defined by the at least partially circumferential surface of section 503, ridge 509 (and similarly ridges 519, 529 described below) only can extend transversely on the respective flat surface 507, 517, 527, without extending at least partially circumferentially around respective shafts 502, 512, 522. In the embodiment of FIG. 5A, set screw 515 of a pinion gear is illustrated as being held between ridge 509 and cylindrical section 503. The rest of the pinion gear is not shown for sake of clarity.

FIG. 5B illustrates motor 501 coupled to shaft 512. Shaft 512 includes a cylindrical section 503 having a substantially circular cross-sectional shape in a plane perpendicular to the plane of FIG. 5B. In some embodiments, section 503 may be located entirely within motor 501. Shaft 512 also includes a section 515 having a flat surface 517. On flat surface 517 are two ridges 519. Each of ridges 519 physically may be substantially the same as ridge 509 of FIG. 5A. In the embodiment of FIG. 5B, set screw 515 is illustrated as being held between ridges 519.

FIG. 5C illustrates motor 501 coupled to shaft 522. Shaft 522 includes a cylindrical section 503 having a substantially circular cross-sectional shape in a plane perpendicular to the plane of FIG. 5C. In some embodiments, section 503 may be located entirely within motor 501. Shaft 522 also includes a section 525 having a flat surface 527. On flat surface 527 is a plurality of ridges 519. Each of ridges 519 physically may be substantially the same as ridge 509 of FIG. 5A. In the embodiment of FIG. 5C, set screw 515 is illustrated as being held between two of ridges 519. The plurality of ridges allows for axial adjustability when coupling a pinion to shaft 522, similar to the embodiment of FIG. 4E. For sake of clarity, not all ridges in FIG. 5C are marked with a reference number.

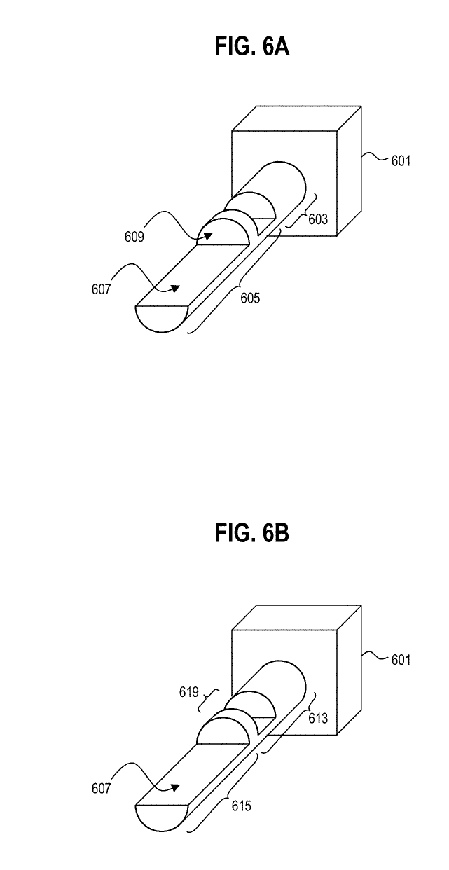

FIG. 6A illustrates an oblique view of an embodiment in accordance with the present disclosure, similar to the embodiment illustrated in FIG. 5A. FIG. 6A includes a motor 601 coupled to a shaft. The shaft includes a cylindrical section 603 and a section 605 having a flat surface 607. On flat surface 607 is a single ridge 609. Ridge 609 extends in a transverse direction, i.e., in a direction perpendicular to the lateral length of the shaft. Since ridge 609 cannot extend radially beyond a cylindrical envelope defined by the at least partially circumferential surface of section 603, ridge 609 only can extend transversely on the respective flat surface 607, without extending at least partially circumferentially around the shaft. However, ridge 609 does not necessarily extend completely to the cylindrical envelope, and various ridge shapes within the cylindrical envelope are possible. A set screw (not illustrated) would be held between ridge 609 and cylindrical section 603. Although ridge 609 is illustrated with sharp convex edges, in other embodiments ridge 609 may have rounded convex edges similar to ridge 509 of FIG. 5A. The embodiment of FIG. 6A is otherwise similar to the embodiment of FIG. 5A.

FIG. 6B illustrates an alternate interpretation of the physical configuration shown in FIG. 6A. FIG. 6B illustrates a shaft having a cylindrical section 613 and a section 615 having a flat surface 607. Cylindrical section 613 is interpreted as including a notch 619. The portion of the shaft interpreted as ridge 609 in FIG. 6A is now considered part of cylindrical section 613. In the embodiment of FIG. 6B, the depth of notch 619 is not necessarily the same as the depth of flat surface 607 below the cylindrical envelope of section 613. Aside from the location of notch 619 being in cylindrical section 613, notch 619 otherwise may be substantially similar to the notches illustrated in FIGS. 4B-4E.

Embodiments in accordance with the present disclosure are also usable with a motor shaft that does not have a D-shaped portion, i.e., a motor shaft that is substantially cylindrical along its entire length except for surface feature(s). The surface feature in this case would be a notch extending at least partially circumferentially around the shaft. Such an embodiment may be more susceptible to rotational slippage compared to the embodiments of FIG. 3 through FIG. 6B.

While the foregoing is directed to embodiments of the present invention, other and further embodiments of the present invention may be devised without departing from the basic scope thereof. It is understood that various embodiments described herein may be utilized in combination with any other embodiment described, without departing from the scope contained herein. Further, the foregoing description is not intended to be exhaustive or to limit the invention to the precise form disclosed. Modifications and variations are possible in light of the above teachings or may be acquired from practice of the invention. Certain exemplary embodiments may be identified by use of an open-ended list that includes wording to indicate that the list items are representative of the embodiments and that the list is not intended to represent a closed list exclusive of further embodiments. Such wording may include “e.g.,” “etc.,” “such as,” “for example,” “and so forth,” “and the like,” etc., and other wording as will be apparent from the surrounding context.

While there have been shown, described, and pointed out fundamental novel features of the invention as applied to a preferred embodiment thereof, it will be understood that various omissions, substitutions, and changes in the form and details of the devices illustrated, and in their operation, may be made by those skilled in the art without departing from the spirit and scope of the invention. For example, it is expressly intended that all combinations of those elements and/or steps which perform substantially the same function, in substantially the same way, to achieve the same results are within the scope of the invention. Substitutions of elements from one described embodiment to another are also fully intended and contemplated. It is also to be understood that the drawings are not necessarily drawn to scale, but that they are merely conceptual in nature. It is the intention, therefore, to be limited only as indicated by the scope of the claims appended hereto.

I claim:

1. A motor shaft, comprising:
a cylindrical-shaped first portion;
a second portion having a D-shaped cross section; and
a surface feature on the motor shaft, the surface feature configured to prevent a set screw from sliding axially along a major axis of the motor shaft.

2. The motor shaft of claim 1, wherein the surface feature comprises a notch.

3. The motor shaft of claim 1, wherein the surface feature comprises a ridge.

4. The motor shaft of claim 2, wherein the notch comprises a notch in the second portion of the motor shaft.

5. The motor shaft of claim 2, wherein the notch comprises a notch in the first portion of the motor shaft.

6. The motor shaft of claim 2, wherein the notch extends at least partially circumferentially around the motor shaft.

7. The motor shaft of claim 1, wherein the surface feature comprises a rounded transition from the motor shaft to the surface feature.

8. The motor shaft of claim 1, wherein a set screw of a pinion gear is secured in the surface feature in order to prevent movement of the pinion gear along an axial direction of the motor shaft.

9. The motor shaft of claim 1, wherein a set screw of a pinion gear is secured between the surface feature and a second surface feature in order to prevent movement of the pinion gear along an axial direction of the motor shaft.

10. The motor shaft of claim 1, wherein a set screw of a pinion gear is secured between the surface feature and the first portion of the motor shaft.

11. The motor shaft of claim 1, wherein the surface feature comprises a plurality of notches, in order to secure a set screw of a pinion gear at one of a plurality of axial positions on the motor shaft.

12. The motor shaft of claim 1, wherein the surface feature comprises a plurality of ridges, in order to secure a set screw of a pinion gear at one of a plurality of axial positions on the motor shaft.

13. The motor shaft of claim 1, wherein the surface feature is adapted to receive multiple set screws.

14. A motor, comprising:
a housing to enclose electromagnetic coils; and
a motor shaft rotatably coupled to the housing, the motor shaft extending from within the electromagnetic coils to a point outside the housing, the motor shaft comprising:
a cylindrical-shaped first portion;
a second portion having a D-shaped cross section; and
a surface feature on the motor shaft, the surface feature configured to prevent a set screw from sliding axially along a major axis of the motor shaft.

15. The motor of claim 14, wherein the surface feature comprises a notch.

16. The motor of claim 14, wherein the surface feature comprises a ridge.

17. The motor of claim 14, wherein a set screw of a pinion gear is secured in the surface feature in order to prevent movement of the pinion gear along an axial direction of the motor shaft.

18. The motor of claim 14, wherein a set screw of a pinion gear is secured between the surface feature and a second surface feature in order to prevent movement of the pinion gear along an axial direction of the motor shaft.

19. The motor of claim 14, wherein a set screw of a pinion gear is secured between the surface feature and the first portion of the motor shaft.

20. The motor of claim 14, wherein the surface feature comprises a plurality of ridges, in order to secure a set screw of a pinion gear at one of a plurality of axial positions on the motor shaft.
